(19) United States
(12) Patent Application Publication
(10) Pub. No.: US 2013/0255356 A1
(43) Pub. Date: Oct. 3, 2013

(54) METHOD FOR TESTING A DEVICE FOR PROTECTING AGAINST PIERCING ELEMENTS

(71) Applicant: Jérome Le Carpentier, Saint Aubin Du Thenney (FR)

(72) Inventor: Jérome Le Carpentier, Saint Aubin Du Thenney (FR)

(73) Assignee: Compagnie Europeenne De Developpement Industriel- CEDI, Paris (FR)

(21) Appl. No.: 13/824,021

(22) PCT Filed: Dec. 21, 2011
(86) PCT No.: PCT/EP11/73547

§ 371 Date: Mar. 15, 2013

(30) Foreign Application Priority Data
Dec. 21, 2010 (FR) 1060958

(51) Int. Cl. G01N 3/00

(52) U.S. Cl. CPC G01N 3/00
USPC 73/11.04

(57) ABSTRACT

The invention relates to a method for testing a device for protecting against piercing elements, such as ammunition or weapons with blades that can pierce human beings, said method including the following steps: providing a block of plastically deformable material; fitting the block with the protection device to be tested; applying the piercing elements to the protection device with a series of predetermined levels of energy and kinematics; measuring the sizes of the impacts of the piercing elements in the block of plastically deformable material, and obtaining a series of measurements of mechanical parameters resulting from the piercing elements; and converting the series of measurements using conversion data obtained by a conversion method according to the invention, so as to deduce therefrom the corresponding mechanical properties resulting from the piercing elements on a dummy.

### FIELD OF THE INVENTION

This invention generally relates to protective clothing or equipment for people, in particular law enforcement forces and/or armed forces, against the firing of ammunitions or piercing weapons of the punch or knife type etc.

This invention relates in particular to the methods for evaluating the protection provided by such protective clothing or devices, and the design and manufacture of clothing or devices having given protective properties.

### PRIOR ART

Various methods for measuring the effectiveness of protective clothing or devices against the firing of ammunitions or piercing weapons are already known.

Conventionally, and in accordance with the various standards on the resistance of body protection equipment to bullets and other piercing weapons, and in particular according to the American standard NIJ 0101.06, Plastiline®, a paste with a standardised hardness, in the form of a block with a weight of 80 kg maintained at a temperature of 20° C. or equivalent Fahrenheit, is used.

The method consists in fixing the equipment to be tested onto such a block using straps, and in carrying out the firing on this equipment at a determined distance—in general five metres for handguns and ten to fifteen metres for the so-called long guns—with this firing being carried out using a shooting bench firing ammunitions with a standardised weight at a speed which is also standardised.

The equipment tested is approved if it fulfils the following two conditions:
it stops the projectile fired by the shooting bench,
the maximum depth of the imprint of the impact in the block of Plastiline® located immediately behind the protective device does not exceed a determined depth (generally fixed by an ordering party), typically for example 44 mm, with this depth measured using a calliper gauge.

As Plastiline® is a relatively economical and rather common material, this method has the advantage of being economical and of great facility in implementation for firing testing laboratories, for testing protective devices developed by industrialists.

It does however have the disadvantage of not making it possible to deduce, using the measurement of the depths of the impacts made in the block of Plastiline®, the traumatological consequences of the impacts of ammunitions or stabbing with knives on a subject wearing the device.

In addition, during these tests, the measurements of the deformation of the Plastiline® can be distorted as the firings are carried out, because Plastiline® is a material of which the mechanical behaviour depends greatly on its temperature, as the increase in temperature resultant from the successive impacts of ammunitions in the block of Plastiline® can be sufficient to distort the results.

Patent application FR 2 933 181 A proposes the implementation of an instrumented dummy of the Hybrid III type (marketed by the company ETD, Hittfeld, D-21218 Seevetal, Germany), provided with sensors arranged in a test region, for example the abdomen, thorax, head, vertebrae, vertebral column, etc.

These sensors make it possible, by measuring parameters such as for example forces, moments and accelerations according to several axes, on the surface of the dummy, to give indications of a traumatological nature of the effect of the impacts on the human body.

A dummy of this type is however extremely expensive, and the use of ammunitions risks deteriorating it substantially and irremediably. For this purpose, according to FR 2 933 181 A, the dummy is therefore provided with a protection forming a deadweight in front of the region or regions provided with sensors.

Projectile firing tests are then carried out:
on the one hand on the dummy provided with the protection but devoid of the equipment or of the protective piece of clothing that is to be tested, in order to obtain a first series of mechanical measurements thanks to the sensors of the dummy,
and on the other hand on the dummy provided with the protection as well as the equipment or protective piece of clothing to be tested, in order to obtain a second series of mechanical measurements.

Following these firings of projectiles, the two series of measurements are compared in order to deduce from them the effectiveness of the equipment or of the protective piece of clothing tested.

This solution has the advantage of being able to determine the persistent traumatological risks during the use of a protection device, and this, thanks to the sensors arranged on the dummy and to the structural characteristics of the dummy.

However, this solution is difficult to implement for regular tests. Indeed, the dummies used in this type of methods are so expensive that it is impossible for approved firing laboratories to be provided with such dummies. It is then required, during the testing process of a piece of equipment, and even for its approval, to outsource the tests to a centralised institute that has this type of equipment.

Yet the very low availability of these dummies sometimes imposes very long periods of time in order to carry out these tests, and can also require moving them from one testing centre to another, which generates costs and delays that are constraining in designing protection devices.

Furthermore, the measurements taken by the sensors are not fully representative of the traumatological effects for the wearer of the device, in that they can be distorted by the presence of the protections of the dummy, as these protections are even all the more important and able to distort the measurements as the firing of the tests is done with powerful weapons.

As such the firing of ammunitions with high-firepower firearms is able to cause a deterioration of the dummy.

Finally, this method is difficult to implement reliably and economically for testing the resistance of a protection device with ammunitions of a substantial calibre, where the dummy risks being deteriorated by the firings if the protections used are not adapted.

### SUMMARY OF THE INVENTION

An objective of this invention is to propose a method for testing a protection device with regards to piercing elements such as ammunitions or weapons with blades that can pierce human beings that overcomes all or a portion of the aforementioned disadvantages.

In this respect, the invention proposes a method for converting measurements of plastic deformation in a block of plastically deformable material (PL) into kinematic and energy data on a dummy (D) for the purposes of designing protective equipment for people such as law enforcement forces and/or the armed forces, comprising the following steps:

(a) providing a dummy of which at least one region is provided with sensors, with a standard protective device being placed on said region,

(b) carrying out a series of firings of piercing elements in fixed conditions on said region of the dummy,

(c) recording kinematic measurements supplied by the sensors (SEN) during these series of firings,

(d) providing a block of plastically deformable material provided with a protective device identical to the one used in the step (a),

(e) carrying out series of firings identical to those of the step (b) on the block of material,

(f) carrying out measurements of deformations of the block of material caused by the impacts of these series of firings,

(g) repeating steps (a) to (f) with standard protective devices having different characteristics, and

(h) using kinematic measurements supplied by the sensors (SEN) and measurements of deformations observed on the block of material for identical firings and the various standard protective devices, determining conversion data.

Certain preferred but not restrictive aspects of the method of conversion according to the invention are as follows:
each protective device comprises a defined number of sheets of ballistic fibres;
at least one of the parameters of the following group of the block of plastically deformable material is controlled: temperature, mass, composition and hardness of the block;
the block of plastically deformable material used is a block of Plastiline®;
at least one of the parameters of the ambient air from among the following group is controlled: temperature of the air, spleen of humidity in the air;
during a series of firings, several ammunitions of the same calibre and of the same mass are fired in the region of the dummy provided with sensors;
the region of the dummy that is fired upon is one of the regions from the following group: the head, thorax, pelvis, back, neck, lower abdomen;
a plurality of zones at risk are fired upon;
the zones at risk are at least one of the following zones: heart, upper and/or lower portion of the right lung, upper and/or lower portion of the left lung, sternum, upper ribs, lower ribs, pancreas, vertebral column, spleen, kidney;
during a series of firings, each zone at risk is fired upon one time;
during a series of firings, the zones at risk are fired upon in a determined order.
the same zones of the protection device are fired upon in the steps (b) and (e);
during the step (e), the firing zones are identified by means of a template arranged on the protection device;
the dummy is standing up and maintained via suspension at the time of the firing, with the suspension being released immediately before the impact of the firings;
the kinematic measurements supplied by the sensors include at least one of the elements from the following group: a longitudinal acceleration, a vertical acceleration, a transverse acceleration, the resultant of a longitudinal moment, a vertical moment, a transverse moment, a deflection of the surface of the material, and wherein one can furthermore measure at least one of the elements from the following group: speed of the bullet when fired, speed of the bullet at arrival on the dummy or on the block of material, speed of the bullet at a predetermined distance from the dummy or from the block of plastically deformable material where applicable;
the measurements of deformation of the plastically deformable material include at least one of the elements from the following group: a depth and a diameter;
the ammunitions are of large calibre, and the protection devices used comprise an armour;
conversion data that is specific to a type of ammunition is determined;
conversion data that is specific to a size of a protection device is developed; and
each series of firings is carried out at different distances from the dummy and/or from the plastically deformable block.

According to a second aspect, the invention proposes a method for testing a protection device with regards to piercing elements such as ammunitions or weapons with blades that can pierce human beings comprising the following steps:
providing a block of plastically deformable material,
providing the block with the protection device to be tested,
applying piercing elements according to a series of determined energies and kinematics on the protection device,
measuring dimensions of the impact of the piercing elements in the block of plastically deformable material, and obtaining a series of measurements of mechanical parameters resulting from the action of the piercing elements, and
converting the series of measurements using conversion data determined by a method of conversion in accordance with the invention in such a way as to deduce from it the corresponding mechanical parameters resulting from the action of the piercing elements on a dummy.

A preferred but not restrictive aspect of the method for testing according to the invention is that it further comprises a step of determining traumatological risks using conversion data.

According to a last aspect, the invention proposes a method for designing a protection device for people such as law enforcement forces and/or armed forces against the action of piercing elements such as ammunitions or weapons with blades that can pierce, comprising the following steps:
carrying out the method for testing a protection device in accordance with the invention on a prototype of a protective device,
deducing from the previous step a degree of protection provided by the prototype of a protective device,
according to the requirements concerning the degree of protection of the equipment to be designed, modifying the characteristics of the prototype, and
reiterating the preceding steps until a degree of protection is obtained according to the requirements.

A preferred but not restrictive aspect of the method for designing according to the invention is that it further comprises a step of determining traumatological risks associated with the degree of protection of the prototype designed as such.

### BRIEF DESCRIPTION OF THE FIGURES

Other characteristics, purposes and advantages of this invention shall appear when reading the following detailed description, with regards to the annexed figures, provided by way of non-restricted examples and wherein:

FIG. 1 shows the elements required to carry out the steps of the method according to the invention during which a series of measurements are taken on a dummy provided with sensors,

FIG. 2 shows the elements required for carrying out a step of the method according to the invention during which a series of measurements are taken on a block of plastically deformable material.

FIG. 3 shows the mechanical components measured by the sensors of the dummy, shown by way of example on the plane of the torso of the dummy.

FIG. 4a shows an example of a protection device provided with a layer of armour.

FIG. 4b is a cross-section view of the equipment of FIG. 4a.

FIG. 5a shows an example of a protection device of the “stand-alone” type, and

FIG. 5b is a cross-section view of the equipment of FIG. 5a.

### DETAILED DESCRIPTION OF A PREFERRED EMBODIMENT

A method shall now be described in detail to convert measurements of plastic deformation in a block of plastically deformable material PL into kinematic and energy data on a dummy D for the purposes of designing protective equipment for people such as law enforcement forces and/or armed forces.

This conversion data therefore makes it possible to test a protection device without recourse to a dummy D, by having recourse solely to a block of plastically deformable material PL, which, among other advantages, substantially reduces the costs of testing protection devices while still making it possible to accelerate the tests and the designing of the devices.

The dummy D used in the method described hereinafter is similar to that which is used in FR 2 933 181 A. It preferably reproduces with accuracy the characteristics of real human beings.

In particular, this dummy D reproduces the zones Z which are today considered as zones at risk, i.e. sensitive zones of the human being and wherein the impact of piercing elements can be lethal. These zones are in particular, for the front surface, the thorax constituted of the ribs and of the sternum and containing the heart and the lungs. Concerning the rear surface, this will in particular entail the ribs and the vertebral column as well as primarily the heart and the lungs. If the abdomen is considered it will entail in particular zones of the liver, spleen, kidneys and pancreas. Note however that the choice of the zones at risk can vary according to the size of the protection device S tested and the type of protection sought.

A rib cage, comprising in particular the upper and lower ribs, and provided with sensors, is furthermore also reproduced in the dummy D, in order to simulate a smashing or a rib fracture which can, according to the circumstances, cause perforations of vital organs.

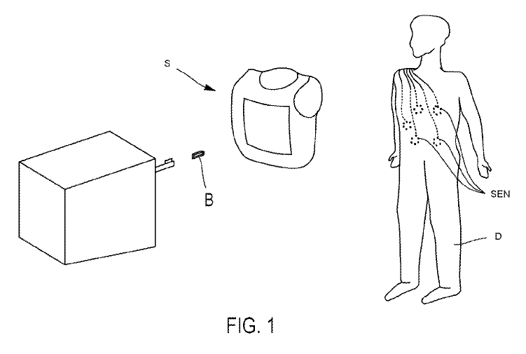

In reference to FIG. 1, a first step of the method consists in setting up a dummy D, of which at least one region is provided with a series of sensors SEN, said region also being provided with a protective device E.

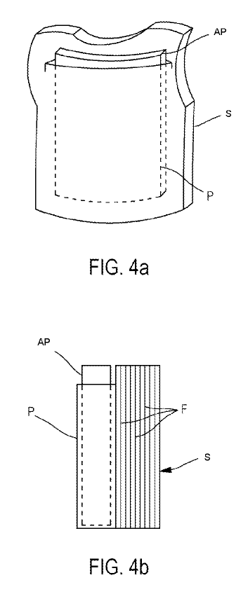

This protective device S is a first standard device chosen from among a set of such devices each comprising a stack of a defined number of sheets of ballistic fibres F, shown in FIG. 4b. These ballistic fibres F can be woven or non-woven, and constituted of materials of different origins and/or families as in particular para-aramids, high-density polyethylenes, carbon nanotubes or any other material that fulfils the same function.

More preferably, in order to be as close as possible to reality, this standard equipment S has the dimensions of a plastron of a protective vest.

Different regions of the dummy D can be provided with such sensors SEN and with standard protection devices S, such as the head, thorax, pelvis, neck, back, lower abdomen, etc.

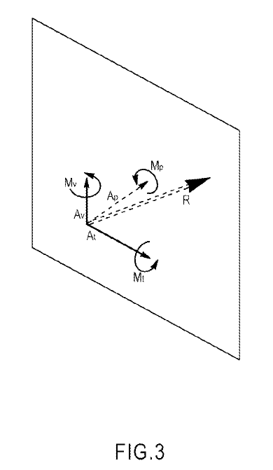

For each of the aforementioned regions, the sensors SEN can measure and detect various magnitudes, of which certain ones are shown in FIG. 3.

Concerning the head and the pelvis, the sensors can measure a longitudinal acceleration Aₗ, a vertical acceleration Aᵥ, a transverse acceleration Aₜ and a resultant of the acceleration R of the piercing elements applied.

The sensors arranged on the thorax or the back measure in particular the longitudinal acceleration Aₗ, the vertical acceleration Aᵥ, the transverse acceleration Aₜ, the resultant of the acceleration R of the piercing elements, as well as the deflection, i.e. the deformation of the surface of the material resulting from the piercing elements applied.

Finally the sensors located on the neck measure in particular on the one hand the efforts, longitudinal, vertical, and transverse (not shown in the figures), and on the other hand the longitudinal Mₗ, vertical Mᵥ and transverse Mₜ moments of the piercing elements applied.

Returning to FIG. 1, a following step of the method according to the invention consists in carrying out, on the region of the dummy D provided with sensors SEN and with the standard protective device S, series of firings with piercing elements such as ammunitions B, whether or not lethal—non-lethal ammunitions of the defence bullet type, can be for example made of rubber or plastic—with each series of firings carried out in particular conditions which are explained hereinafter.

The series of firings are preferably carried out on a dummy D sitting or standing. So that the kinematic measurements taken by the sensors SEN are more realistic, it is preferable to maintain the dummy D in standing position and to release it at the time of the firing so that, under the power of the firing, the dummy D is subjected to similar constraints and is displaced in the same way as a human being.

A helmet connected by a string can be for example fixed to a fixed point on the head of the dummy D, which is released at the time of the firing in order to release the dummy D. Advantageously, the liaison between the helmet and the fixed point can be carried out by means of an electromagnet that can be selectively activated and deactivated with fast reaction via a suitable electrical control.

After these firings, the sensors SEN measure kinematic magnitudes from among the magnitudes mentioned hereinabove, these measurements are then recorded.

If a series of firings is carried out on the thorax of the dummy D, it can consist for example of a series of six firings of ammunitions, with each of the ammunitions being fired in six zones at risk of the rib cage at the defined location of the heart, of the right lung (upper and lower), of the left lung (upper and lower) and of the sternum. This series can possibly be repeated on another identical piece of equipment, so that the firings that have already been carried out do not disturb the new measurements.

In addition to the steps hereinabove, a block of plastically deformable material PL is set in place, whereon is attached a standard protective device S that has the same characteristics as that whereon the series of firings was carried out.

The block of plastically deformable material PL can for example be a block of Plastiline® PL with controlled characteristics, in particular its mass, its temperature, its hardness and its composition. These characteristics can be compliant with a standard of a given country, as standards vary according to the countries, there is actually no single standard concerning Plastiline®.

The blocks of Plastiline® PL conventionally used weigh in general 80 kg and are used at a temperature of 20° C.

In the case where the region of the dummy D whereon the series of firings that was carried out is the thorax, the block of plastically deformable material PL can furthermore have a similar curvature, and more preferably as close as is possible, to the natural curvature of a torso of a human being. This makes it possible to improve and to facilitate the quality of the correspondence between the measurements taken on the dummy D and the measurements taken on the plastically deformable material PL.

In this case, a Plastiline® Herbin Sueur 40 will more preferably be used, as the other blocks of Plastiline® are generally pre-shaped in a cube-shaped tray (as for example Plastiline® ROMA no. 1).

In order to carry out the tests, more preferably is attached to the block of plastically deformable material PL the portions corresponding to the back and to the plastron of the standard protective device S in order to record results that are as close as possible to reality, with the rest of the device not being required.

Alternatively, in the case of a block of Plastiline® PL that does not have a curvature that is similar to that of the torso, the tests are carried out more preferably by successively placing the plastron and the back of the protection device S on the block of Plastiline® PL, for example thanks to elastic bands as described in standard NIJ010106.

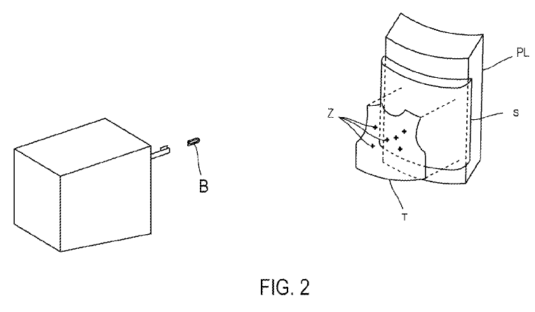

In reference to FIG. 2, one or several series of firings identical to those carried out on the dummy D (same firing zone, same distance, etc.) are then carried out on this unit.

The piercing elements used leave on the block of plastically deformable material PL imprints linked to their impacts. Certain characteristics of these imprints are then measured, in particular their depth, in accordance with the standard NIJ 0101.06, and their diameter (parameter which is not indicated in standard NIJ 0101.06), which makes it possible to obtain a series of measurements of mechanical parameters resulting from the action of the piercing elements on the block of plastically deformable material PL.

A following step of the method according to the invention then consists in confronting the series of measurements of deformations in the block of plastically deformable material PL, with the kinematic and energy data obtained with the dummy D respectively for the various standard protections S, in order to deduce from them conversion data, thanks to a correspondence between these two types of series of measurements.

Each series of firings is carried out with a large number of constant and carefully controlled parameters so that the conversion data is as reliable and as accurate as possible.

Parameters such as the temperature and the moisture content of the ambient air are more preferably controlled during the tests.

Furthermore, for a given confrontation between two series of equivalent firings, the series of firings are carried out with certain constant parameters such as: the type of the ammunition (i.e. its calibre, its nature, its load (weight, shape, composition, etc.), its speed of firing), the zone Z of the dummy D whereon the firing was carried out, the firing distance in relation to the dummy D and to the block of plastically deformable material PL.

Moreover, the series of firings preferably comprises a firing of ammunition per zone Z (advantageously per zone at risk), in a determined order.

More preferably, the firings are on the one hand carried out at the same locations of the equipment of the plastically deformable material PL and of the dummy D, and on the other hand in the same order. This makes it possible to be able to exactly transpose the results obtained on the dummy D and those obtained on the block of plastically deformable material PL.

Typically, if the step of firing on the thorax of the dummy D consists in firing ammunition in a standard equipment on each zone at risk Z (for example for the rib cage: heart, left lung—upper and lower portions, right lung—upper and lower portions, sternum), then at the time of carrying out the analogous series of firings in the block of plastically deformable material PL, the six firings must be carried out exactly at the same locations of the plastron of the standard equipment, corresponding to said zones at risk Z.

In order to guarantee that the zones Z wherein the firings are carried out indeed correspond to the zones at risk Z of the dummy D, a template T can be used for the purposes of assistance, whereon are mentioned the exact locations of said zones Z. This template T can be placed for example on the standard protection device before the firings on the dummy D, then recovered) in order to be placed on the standard protection device S in order to precisely locate the corresponding zones for the firing on the block PL. Alternatively, the template is not recovered but is replaced with an identical template whereon the impacts of ammunitions fired on the dummy D will have been marked beforehand.

Of course, the size of the protection device S (and therefore of the plastron) is also very important for the reliability of the measurements, since on a protection device of small size, a vital organ such as the heart is located closer to the edge of the equipment and as such is not as well protected since it comprises less ballistic surface than equipment of a larger size.

Consequently, the tests on dummy D or on plastically deformable material PL are also carried out on protection devices S of the same size for the establishment of a set of conversion data. Different series of firings for different sizes of protection devices S must then be carried out, for example for testing devices for men or for women, of sizes S, M, L, XL or XXL.

Furthermore, in the tests on the dummy D as in the tests on the plastically deformable block PL, the tests are carried out here in accordance with the American standard NIJ 0101.06.

As such, during a series of firings, each impact of ammunition must be located at a minimum distance (typically 7.6 cm) from the edges of the plastron of the protection device E, and at a minimum distance (typically 5.1 cm) respectively from another ammunition impact, in order to avoid any edge effect.

The choice of the ammunitions is also very important. As was mentioned, each series of firings is carried out with ammunitions of constant calibre, mass, load, nature, shape, composition, and speed, which are more preferably in accordance with the types of ammunitions mentioned in the American standard NIJ 0101.06.

The mass of an ammunition comprises, in addition to the mass of the bullet fired, the mass of the powder, which directly influences the speed of the bullet fired. This means that a given mass of ammunition corresponds to a given bullet speed at the exit of the weapon, and that by increasing the quantity of powder in an ammunition, the bullet fired can be given a speed, and therefore a kinetic energy, that is much higher.

Generally, the aforementioned standard imposes the use of ammunitions of which the characteristics are perfectly defined and can be summarised in speed and in nature. If it is necessary to test the protection device S for an ammunition that is not described in the standard, its speed must then be measured and its weight must be defined, and all of the firings on the block of plastically deformable material PL and on the dummy must be carried out with this ammunition.

However, at a fixed mass, many parameters can cause the speed of the ammunition exiting the barrel to vary, for example the state of the carriage of the weapon, friction, the nature of the ammunition etc.

In order to overcome this disadvantage, the American standard NIJ 0101.06 imposes for example a precise speed of ammunition, with a tolerance of plus or minus 9.1 m/s.

Consequently, during the tests, as each ammunition fired can have a speed that is different from the previous one (but always included within the tolerance authorised by the standard), each series of tests can be carried out several times, for example about ten times, in order to obtain a representative statistical sample allowing for correlations that are as accurate as possible.

This also makes it possible to immediately detect an aberrant result when this correlation data is used.

During the step consisting of firing on the dummy D, as during the step consisting of firing on the block of plastically deformable material PL, at least one of the speeds is in addition measured from among the following group: speed of the ammunition at the exit of firing (i.e. as the exit of the barrel of the weapon used), speed of the ammunition at arrival on the dummy D and on the block of material PL, speed of the ammunition before the impact, for example at a predetermined distance from the dummy D or from the block of material PL where applicable (typically at 2.50 m).

For conventional protection devices constituted solely of ballistic fibres, the ammunitions used belong to the classes IIA to IIIA of the American standard NIJ 0101.06, which corresponds to small to high calibres (handguns), for example from the 40S&W FMJ to the 44Magnum SJHP.

For ammunitions of higher calibres, for example ammunitions entering into the class III or IV, the standard protection devices used are provided with additional armour, in order to stop the ammunitions. Indeed, only the presence of such an armour makes it possible to stop calibres of such a nature.

The armour is constituted of an armour plate AP, for example made of ceramic of the boron, silicon or alumina carbide type, or of high-density polyethylene, with this armour plate AP placed on the front of the protection device, for example the plastron, inside a pocket P provided for this purpose, as shown in FIGS. 4a and 4b.

With these devices tests are carried out with ammunitions such as defined by example in the standard NIJ0101.06 for level III and IV, corresponding to large calibre, in accordance with the steps described hereinabove for classes IIA, II, IIIA (small to large calibres), and also obtain correlation data for these calibres.

It is also possible carry out for these devices tests with certain ammunitions that are different from those which are indicated in the standard, as for example ammunitions of calibre 12 BRENNEKE.

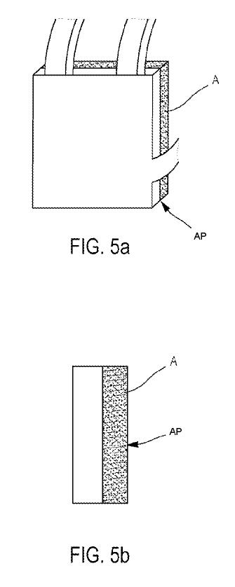

There are also plates that are adapted to be put on directly (without any other protection device) and which can be retained by a harness (referred to as stand-alone plates); an example of such a plate is shown in FIGS. 5a and 5b. These plates of armour are similar to the previous ones, but also incorporate a damping layer A (for example constituted of foam, aramid or any other material able to constitute an effective shock absorber) on the rear of the armour adapted to provide the absorbing of the bullets.

These plates also make it possible to provide protection with regards to ammunitions belonging to classes III or IV. However, in the event of an impact of ammunition, the reaction of such a plate is different from the reaction of a protection device comprising a conventional armour plate.

Indeed, as stand-alone plates are attached only by harnesses, they are much more mobile and less stabilised than protection devices containing an armour plate. Consequently, the method according to the invention also provides for carrying out series of tests on such plates in order to obtain conversion data that is specific to the latter.

Using the conversion data obtained thanks to the method according to the invention, and since the tests carried out on the dummy D make it possible to deduce certain traumatological information, it is also possible to establish a correlation between the impacts of the piercing elements on the block of plastically deformable material PL and the traumatological risks occasioned by said piercing elements.

In particular, in light of the structural characteristics of the dummy D mentioned hereinabove, it is possible to determine, for firings carried out on the thorax, risks of smashing or of fractures of ribs, or risks of perforations of organs, and for firings carried out on the back, risks for the vertebral column such as risks of fracture or reaching the spinal cord, using data coming from experience and associating the traumatology with values in particular acceleration, force and moment.

In any case, it is possible to evaluate with these measurements the probability that a human being affected by a given ammunition, with a given protection device, of being able to riposte or not.

These correlations can for example, but in a non-restricted manner, take the form of charts or tables of values stored in the memory of a computer. An automatic conversion software can moreover be developed using these correlations. These correlations are specific to the set of parameters chosen at the time of the series of firings, i.e. at a fixed calibre, fixed mass of ammunition, fixed firing distance, fixed firing zone, fixed speed of firing, etc.

The aforementioned steps are repeated with standard protective devices S of different sizes from among the group S, M, L, XL or XXL, for men or for women, or comprising for example a different number of sheets of ballistic fibres, by way of a non-restricted example, in accordance with the table hereinbelow:

| Number | | | Speed when | Speed at | Speed |
|---|---|---|---|---|---|
| of | | | exiting | 2.50 m from | at |
| sheets | Calibre | Weight | the barrel | the target | impact |
| 8 | | | | | |
| 12 | | | | | |
| 16 | | | | | |
| 20 | | | | | |
| 24 | | | | | |

The conversion data can also be enriched by repeating the aforementioned steps by varying each of the different fixed parameters for each series of firings, i.e. the calibre of the ammunitions, the firing distance, the mass of the ammunitions and the firing speed of the ammunitions, these two last parameters being modified in a correlated manner in order to vary the kinetic energy of the ammunition at the exit of the weapon, with this energy defined by the formula

$${E}_{c} = \frac{1}{2} {mV}^{2} ,$$

with E_{c} the kinetic energy of the ammunition,

m the mass of the ammunition and

V the firing speed of the ammunition.

Once this correspondence is established, it is then possible to carry out a test method of a protection device developed by an industrialist.

In order to do this, the industrialist entrusts the protection device to be tested to an approved firing laboratory.

The test laboratory, which can easily procure a block of plastically deformable material PL of the Plastiline® type, can set up such a block, and equip it with the protection device to be tested.

Then, it applies on this set a series of firings according to determined conditions (distance, zones Z corresponding to the zones of the dummy (where applicable using the template T), etc.), and with a type of ammunition having an interest for the industrialist and corresponding to the type of equipment tested.

The deformations of the block of plastically deformable material PL (depth and diameter) are then measured and compared with the conversion data obtained during the method described hereinabove.

Thanks to the use of the conversion data, the corresponding kinematic magnitudes resulting from the application of identical series of firings on a dummy D are deduced. Advantageously, thanks to the prior interpretation of these kinematic magnitudes in terms of traumatology or of probability of riposte, a degree of protection of the tested protection device can also be deduced.

If the ammunitions used do not correspond to ammunitions for which the conversion data have been determined, it is possible to deduce through extrapolation pre-established conversion data, with the results corresponding to these ammunitions.

This therefore makes it possible, by carrying out tests on a block of plastically deformable material PL only, to be able to deduce thanks to the aforementioned correlation the equivalent results that would have been obtained by carrying out the tests on a dummy D.

This latter aspect of the invention allows the industrialist, a public purchaser, or any other responsible person in the sector to measure for less costs in terms of traumatology the effectiveness of the protection of a given protection device.

Furthermore, since the present method of testing a protection device makes it possible to evaluate certain traumatological risks, this makes it possible to facilitate the orientation of the research in order to improve protection devices.

Finally, if the degree of protection evaluated for a protection device tested thanks to the method of testing described hereinabove is not compliant with the level required by a given standard or ordering party (public purchaser, programme, etc.), the protection device can be modified or, if it is a prototype, its design can be supplemented before being retested according to the same method.

As such, the method of testing a prototype can be reiterated as many times as necessary in order to obtain a protection device that has a degree of protection in accordance with the requirements.

Advantageously, an additional step of determining traumatological risks associated with a degree of protection of the protection device designed as such can be carried out.

Of course, this invention is in no way limited to the embodiment described hereinabove and shown on the drawings, but those skilled in the art will know how to provide many alternatives and modifications.

1. Method for converting measurements of plastic deformation in a block of plastically deformable material into kinematic and energy data on a dummy for the purposes of designing protective equipment for people such as law enforcement forces and/or armed forces, comprising the following steps:
(a) providing a dummy of which at least one region is provided with sensors, with a standard protective device being placed on said region,
(b) carrying out series of firings of piercing elements in fixed conditions on said region of the dummy,
(c) recording kinematic measurements supplied by the sensors during these series of firings,
(d) providing a block of plastically deformable material provided with a protective device identical to the one used in the step (a),
(e) carrying out series of firings identical to those of the step (b) on the block of material,
(f) carrying out measurements of deformations of the block of material caused by the impacts of these series of firings,
(g) repeating steps (a) to (f) with standard protective devices having different characteristics, and
(h) using kinematic measurements supplied by the sensors and measurements of deformations observed on the block of material for identical firings and the various standard protective devices, determining conversion data.

2. Method according to claim 1, wherein each protective device comprises a defined number of sheets of ballistic fibres (F).

3. Method according to claim 1, wherein at least one of the parameters of the following group of the block of plastically deformable material is controlled: temperature, mass, composition and hardness of the block.

4. Method according to claim 1, wherein the block of plastically deformable material is a block of Plastiline®.

5. Method according to claim 1, wherein at least one of the parameters of the ambient air among the following group is controlled: temperature of the air, moisture content of the air.

6. Method according to claim 1, wherein, during a series of firings, several ammunitions of the same calibre and of the same mass are fired in the region of the dummy provided with sensors.

7. Method according to claim 1, wherein the region of the dummy is one of the regions of the following group: the head, thorax, pelvis, back, neck, lower abdomen.

8. Method according to claim 7, wherein the region of the dummy provided with sensors is the thorax, and the block of plastically deformable material has a curvature similar to that of a human thorax.

9. Method according to claim 1, wherein a plurality of zones at risk are fired into.

10. Method according to claim 9, wherein the zones at risk are at least one of the following zones: heart, upper and/or lower portion of the right lung, upper and/or lower portion of the left lung, sternum, upper ribs, lower ribs, pancreas, vertebral column, spleen, kidney.

11. Method according to claim 9, wherein, during a series of firings, one firing is carried out in each zone at risk.

12. Method according to claim 9, wherein, during a series of firings, the zones at risk are fired upon in a determined order.

13. Method according to claim 9, wherein the same zones of the protection device are fired upon in the steps (b) and (e).

14. Method according to claim 13, wherein, during the step (e), the zones are identified by means of a template (T) arranged on the protection device.

15. Method according to claim 1, wherein the dummy is standing up and maintained via suspension at the time of the firing, with the suspension being released immediately before the impact of the firings.

16. Method according to claim 1, wherein the kinematic measurements supplied by the sensors include at least one of the elements of the following group: a longitudinal acceleration, a vertical acceleration, a transverse acceleration, the resultant of a longitudinal moment, a vertical moment, a transverse moment, a deflection of the surface of the material, and wherein at least one of the elements of the following group can furthermore be measured: speed of the bullet at the exit of the firing, speed of the bullet at arrival on the dummy or on the block of material, speed of the bullet at a predetermined distance of the dummy or of the block of plastically deformable material where applicable.

17. Method according to claim 1, wherein the measurements of deformation of the plastically deformable material include at least one of the elements from the following group: a depth and a diameter.

18. Method according to claim 17, wherein the ammunitions are of large calibre, and the protection devices used comprise an armour.

19. Method according to claim 1, wherein conversion data specific to a type of ammunition is determined.

20. Method according to claim 1, wherein conversion data specific to a size of a protection device is determined.

21. Method according to claim 1, wherein each series of firings is carried out at different distances from the dummy and/or from the plastically deformable block.

22. Method of testing a protection device with regards to piercing elements such as ammunitions or weapons with blades that can pierce the human being comprising the following steps:
providing a block of plastically deformable material,
providing the block with the protection device to be tested,
applying piercing elements according to a series of determined energies and kinematics on the protection device,
measuring dimensions of the impact of the piercing elements in the block of plastically deformable material, and obtaining a series of measurements of mechanical parameters resulting from the action of the piercing elements, and
converting the series of measurements using conversion data determined by the method of claim 1 in such a way as to deduce from it the corresponding mechanical parameters resulting from the action of the piercing elements on a dummy.

23. Method of testing according to claim 22, further comprising a step of determining traumatological risks using conversion data.

24. Method for designing a protection device for people such as law enforcement forces and/or armed forces against the action of piercing elements such as ammunitions or weapons with blades that can pierce, comprising the following steps:
carrying out the method for testing a protection device according to claim 22 on a prototype of a protective device,
deducing from the previous step a degree of protection provided by the prototype of a protective device,
according to the requirements concerning the degree of protection of the equipment to be designed, modifying the characteristics of the prototype,
reiterating the preceding steps until a degree of protection is obtained according to the requirements.

25. Method of designing according to claim 24, further comprising a step of determining traumatological risks associated with the degree of protection of the prototype designed as such.
